(19) United States
(12) Patent Application Publication
(10) Pub. No.: US 2014/0184519 A1
(43) Pub. Date: Jul. 3, 2014

(54) ADAPTING USER INTERFACE BASED ON HANDEDNESS OF USE OF MOBILE COMPUTING DEVICE

(71) Applicants: Hayat Benchenaa, London (GB); Daren P. Wilson, London (GB); Aras Bilgen, Hillsboro, OR (US); Dirk Hohndel, Portland, OR (US)

(72) Inventors: Hayat Benchenaa, London (GB); Daren P. Wilson, London (GB); Aras Bilgen, Hillsboro, OR (US); Dirk Hohndel, Portland, OR (US)

(21) Appl. No.: 13/729,379

(22) Filed: Dec. 28, 2012

(51) Int. Cl. G06F 3/0488

(52) U.S. Cl. CPC G06F 3/0488
USPC 345/173

(57) ABSTRACT

Technologies for adapting a user interface of a mobile computing device includes determining the handedness of use of the mobile computing device by the user and adapting the operation of the user interface based on the determined handedness of use. The handedness of use of the mobile computing device may be determined based on sensor signals and/or user interaction models. For example, the operation of the user interface may be adapted or modified based on whether the user is holding or operating the mobile computing device in his/her left hand or right hand, placement of the user's fingers on the mobile computing device, and/or the like.

### BACKGROUND

Mobile computing devices are becoming ubiquitous tools for personal, business, and social uses. The portability of mobile computing devices is increasing as the size of the devices decrease and processing power increases. In fact, many computing devices are sized to be hand-held by the user to improve ease. Additionally, modern mobile computing devices are equipped with increased processing power and data storage capability to allow such devices to perform advanced processing. Further, many modern mobile computing devices are capable of connecting to various data networks, including the Internet, to retrieve and receive data communications over such networks. As such, modern mobile computing devices are powerful, often personal, tools untethered to a particular location.

To facilitate portability, many mobile computing devices do not include hardware input devices such as a hardware keyboard or mouse. Rather, many modern mobile computing devices rely on touchscreen displays and graphical user interfaces including, virtual keyboards and selection menus, for user interaction and data entry. For example, the user may select an option of a menu using his/her finger or thumb. However, while touchscreen displays facilitate portability and smaller package sizes of mobile computing devices, interaction with the user interface using the touchscreen display can be error prone and difficult due to a combination of factors including, for example, the relatively small size of the mobile computing device, users' tendency to hold the mobile computing device in one or both hands, users' tendency to operate the mobile computing device with a finger or thumb, and the static nature of the displayed user interface.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a mobile computing device having an adaptable user interface;

FIG. 2 is a simplified block diagram of at least one embodiment of an environment of the mobile computing device of FIG. 1;

FIG. 3 is a simplified plan view of the mobile computing device of FIG. 1;

FIG. 4 is a simplified flow diagram of at least one embodiment of method for adapting a user interface of a mobile computing device based on handedness of use that may be executed by the mobile computing device of FIGS. 1-3;

FIG. 5 is a simplified flow diagram of at least one embodiment of method for adapting an input gesture based on the handedness of use that may be executed by the mobile computing device of FIGS. 1-3;

FIGS. 6A and 6B are simplified illustrations of at least one embodiment of a user interface displayed on the mobile computing device of FIGS. 1-3 during execution of the method of FIG. 5;

FIG. 7 is a simplified flow diagram of at least one embodiment of method for adapting a sub-menu display based on the handedness of use that may be executed by the mobile computing device of FIGS. 1-3;

FIG. 8A is a simplified illustration of a user interface displayed on a typical mobile computing device;

FIG. 8B is a simplified illustration of at least one embodiment of a user interface displayed on the mobile computing device of FIGS. 1-3 during execution of the method of FIG. 7;

FIG. 9 is a simplified flow diagram of at least one embodiment of method for adapting a user interface to ignore erroneous input based on the handedness of use that may be executed by the mobile computing device of FIGS. 1-3;

FIGS. 10A and 10B are simplified plan views of the mobile computing device of FIGS. 1-3 during interaction by a user and execution of the method of FIG. 9;

FIG. 11 is a simplified flow diagram of at least one embodiment of method for adapting a user interface controls based on the handedness of use that may be executed by the mobile computing device of FIGS. 1-3; and

FIGS. 12A and 12B are simplified illustrations of at least one embodiment of a user interface displayed on the mobile computing device of FIGS. 1-3 during execution of the method of FIG. 11.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

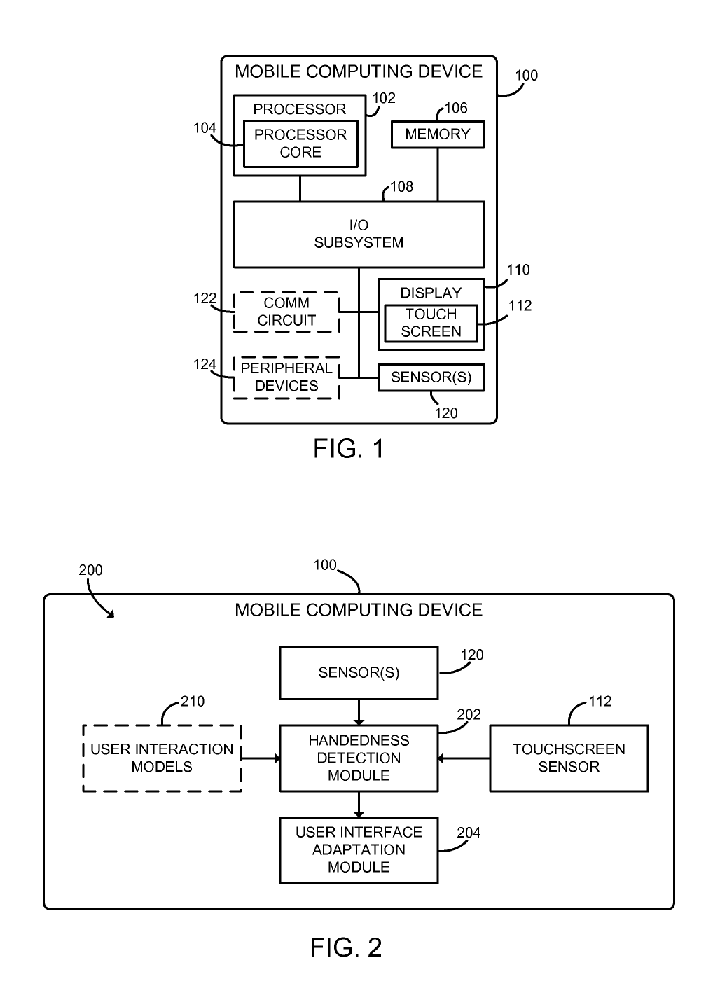

Referring now to FIG. 1, in one embodiment, a mobile computing device 100 configured to adapt operation of a user interface displayed on a touchscreen display 110 includes one or more sensors 120 configured generate sensor signals indicative of the handedness of use of the mobile computing device 100 by a user. That is, as discussed in more detail below, the sensors 120 are arranged and configured to generate sensor signals from which the mobile computing device 100 can infer whether the user is holding the mobile computing device 100 in his/her left hand or right hand and/or which hand the user is using to interact with the mobile computing device 100. Based on the determined handedness of use of the mobile computing device 100 by the user, the mobile computing device 100 adapts operation of a user interface of the device 100. For example, the display location of menus and controls, gesture recognition of the mobile computing device 100, and other user interface features and operations may be modified, transformed, or otherwise adapted based on the particular hand in which the user is holding and/or using to operate the mobile computing device 100. Because the operation of the user interface of the mobile computing device 100 is adapted based on the handedness of use, the user's interaction with the user interface may be more accurate, efficient, and quicker as discussed in more detail below.

The mobile computing device 100 may be embodied as any type of mobile computing device capable of performing the functions described herein. For example, in some embodiments, the mobile computing device 100 may be embodied as a “smart” phone, a tablet computer, a mobile media device, and a game console, a mobile internet device (MID), a personal digital assistant, a laptop computer, a mobile appliance device, or other mobile computing device. As shown in FIG. 1, the illustrative mobile computing device 100 includes a processor 102, a memory 106, an input/output subsystem 108, and a display 110. Of course, the mobile computing device 100 may include other or additional components, such as those commonly found in a mobile computing and/or communication device (e.g., various input/output devices), in other embodiments. Additionally, in some embodiments, one or more of the illustrative components may be incorporated in, or otherwise from a portion of, another component. For example, the memory 106, or portions thereof, may be incorporated in the processor 102 in some embodiments.

The processor 102 may be embodied as any type of processor capable of performing the functions described herein. For example, the processor may be embodied as a single or multi-core processor(s) having one or more processor cores 104, a digital signal processor, a microcontroller, or other processor or processing/controlling circuit. Similarly, the memory 106 may be embodied as any type of volatile or non-volatile memory or data storage currently known or developed in the future and capable of performing the functions described herein. In operation, the memory 106 may store various data and software used during operation of the mobile computing device 100 such as operating systems, applications, programs, libraries, and drivers. The memory 106 is communicatively coupled to the processor 102 via the I/O subsystem 108, which may be embodied as circuitry and/or components to facilitate input/output operations with the processor 102, the memory 106, and other components of the mobile computing device 100. For example, the I/O subsystem 108 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 108 may form a portion of a system-on-a-chip (SoC) and be incorporated, along with the processor 102, the memory 106, and other components of the mobile computing device 100, on a single integrated circuit chip.

The display 110 of the mobile computing device may be embodied as any type of display on which information may be displayed to a user of the mobile computing device. Illustratively, the display 110 is a touchscreen display and includes a corresponding touchscreen sensor 112 to receive tactile input and data entry from the user. The display 110 may be embodied as, or otherwise use, any suitable display technology including, for example, a liquid crystal display (LCD), a light emitting diode (LED) display, a cathode ray tube (CRT) display, a plasma display, and/or other display usable in a mobile computing device. Similarly, the touchscreen sensor 112 may use any suitable touchscreen input technology to detect the user's tactile selection of information displayed on the touchscreen display 110 including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors.

As discussed above, the mobile computing device 100 also includes one or more sensors 120 for detecting the handedness of use of the mobile computing device 100 by the user (e.g., whether the user is holding the mobile computing device is the user's left or right hand). To do so, the sensors 120 are arranged and configured to detect the presence of the user's hand on the mobile computing device 100. For example, the sensors 120 may detect the placement of the user's hand on the case or housing of the mobile computing device 100, detect the location of the user's palm, thumb, and/or finger on the case or housing, detect the movement of the user's thumb or fingers, and/or the like. As such, the sensor(s) 120 may be embodied as any type of sensor capable of generating sensor signals from which the handedness of use of the mobile computing device 100 may be determined or inferred including, but not limited to, capacitive touch sensors, resistive touch sensors, pressure sensors, light sensors, touchscreen sensors, cameras, proximity sensors, accelerometers, gyroscopes, and/or other sensors or sensing elements.

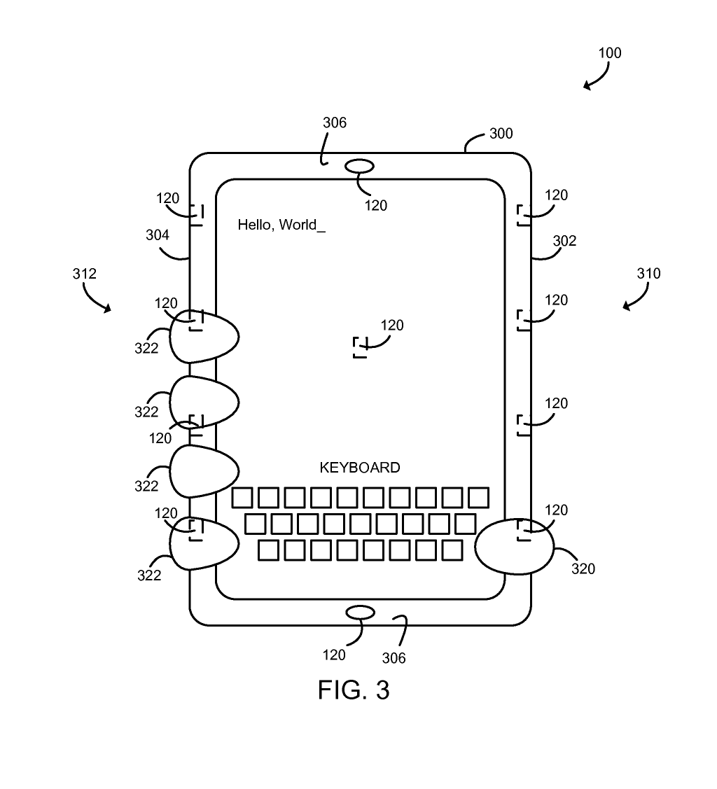

In the illustrative embodiment, the mobile computing device 100 may include multiple sensors 120 secured to, and arranged around, an outer housing of the mobile computing device 100. For example, as shown in FIG. 3, the mobile computing device 100 may include a first set 310 of sensors 120 secured to a right side 302 of a housing 300 of the mobile computing device 100. The first set 310 of sensors 120 are arranged and configured to sense, detect, and/or locate a thumb 320 of the user when the user is holding the mobile computing device 100 in his/her right hand as shown in FIG. 3. Similarly, the first set 310 of sensors 120 are arrange to sense, detect, and/or locate one or more fingers 322 of the user when the user is holding the mobile computing device 100 in his/her left hand. The mobile computing device 100 may also include a corresponding second set 312 of sensors 120 secured to a left side 304 of the housing 300 and arranged and configured to sense, detect, and/or locate the thumb 320 or the fingers 322 of the user depending on the handedness of use of the mobile computing device 100 by the user. The mobile computing device 100 may also include one or more sensors 120 located on a backside (not shown) of the housing 300 to sense, detect, and/or locate the palm of the user. Further, in some embodiments, one or more sensors 120 (e.g., camera, proximity, or light sensors) may be located on a front bezel 306 of the housing 300 to sense, detect, and/or locate the thumb and/or fingers of the user (e.g., to determine the hand being used by the user to interact with the user interface).

Referring back to FIG. 1, in some embodiments, the mobile computing device 100 may also include a communication circuit 122. The communication circuit 122 may be embodied as one or more devices and/or circuitry for enabling communications with one or more remote devices over a network. The communication circuit 122 may be configured to use any suitable communication protocol to communicate with remote devices over such network including, for example, cellular communication protocols, wireless data communication protocols, and/or wired data communication protocols.

In some embodiments, the mobile computing device 100 may further include one or more peripheral devices 124. Such peripheral devices 124 may include any type of peripheral device commonly found in a mobile computing device such as speakers, a hardware keyboard, input/output devices, peripheral communication devices, antennas, and/or other peripheral devices.

Referring now to FIG. 2, in one embodiment, the mobile computing device 100 establishes an environment 200 during operation. The illustrative environment 200 includes a handedness detection module 202 and a user interface adaption module 204, each of which may be embodied as software, firmware, hardware, or a combination thereof. During use, the handedness detection module 202 receives sensor signals from the sensors 120 and determines the current handedness of use of the mobile computing device 100 by the user (e.g., which hand of the user is currently holding the device 100 and/or which hand the user is using to interact with the mobile computing device 100). To do so, in some embodiments, the handedness detection module may compare the output of the sensors 120 to detect the relative location of the user's thumb, fingers, and/or palm and infer the handedness of use of the mobile computing device 100 therefrom. For example, if only one sensor 120 of the first set 310 of sensors 120 of the mobile computing device shown in FIG. 3 indicates the presence of a user's digit (i.e., thumb or finger) and multiple sensors 120 of the second set 312 of sensors 120 indicate the presence of a user's digit, the handedness detection module 202 may infer that the user is holding the mobile computing device 100 in his/her right hand based on the relative location of the user's digits. Additionally, in embodiments in which one or more of the sensors 120 are embodied as a camera or other image-producing sensor, the handedness detection module 202 may perform image analysis on the images produced by such sensors 120 to infer the handedness of use of the mobile computing device 100.

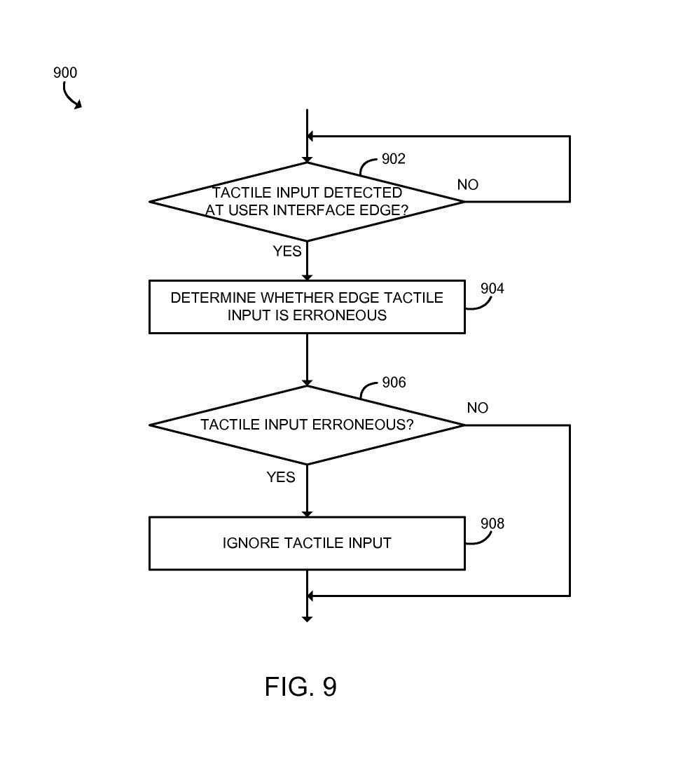

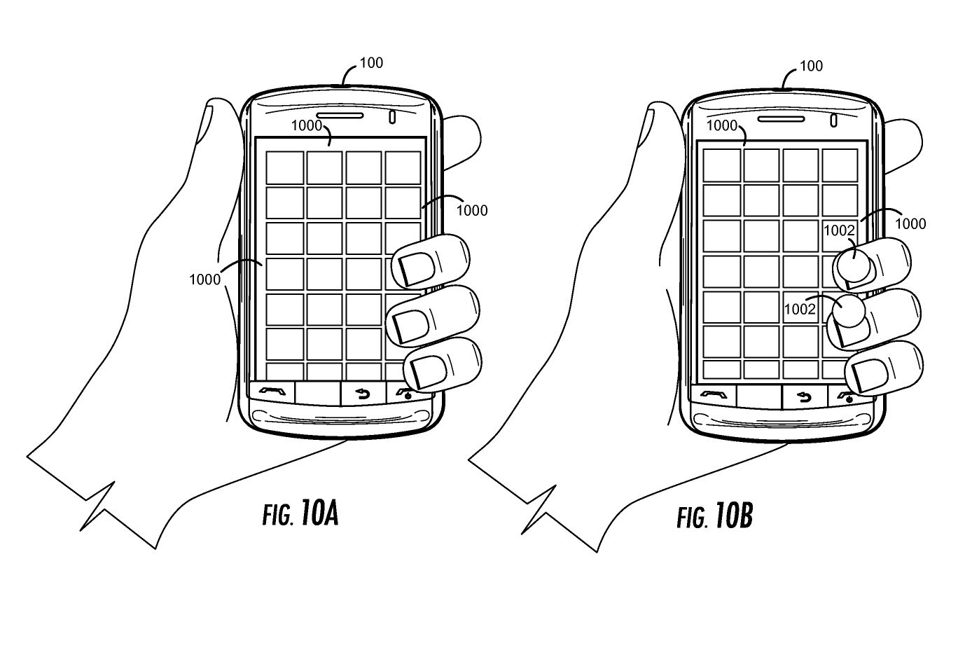

Additionally, the handedness detection module 202 may utilize input data generated by the touchscreen sensor 112 of the touchscreen display 110 to infer handedness of use of the mobile computing device 100. Such input data may supplement the sensor signals received from the sensors 120. For example, the handedness detection module 202 may monitor for the presence or lack of multiple, contemporaneous tactile input, repeated and identical tactile input, and/or other patterns of operation of the mobile computing device 100 that may be indicative of erroneous data input. For example, as discussed in more detail below in regard to FIGS. 9 and 10, the handedness detection module 202 may monitor for contemporaneous tactile input located within an outer edge of the touchscreen display 110, which may indicate erroneous data entry.

In some embodiments, the mobile computing device 100 may store one or more user interaction models 210 in, for example, a data storage or the memory 106. The user interaction models correlate the current user interaction with the mobile computing device 100 to handedness of use of the device 100. For example, the user interaction models may be embodied as historical user interaction data to which the handedness detection module 202 may compare the user's current interaction with the mobile computing device 100 to infer the handedness of use. Such user interaction data may include any type of data indicative of user interaction with the mobile computing device 100 including, but not limited to, patterns of keystrokes or tactile input, selection of graphical icons relative to time of day, erroneous entry corrections, location of tactile input on the touchscreen display 110, location of user's digits inferred from the sensor signals of the sensors 120, and/or other user interaction data.

After the handedness detection module 202 infers the handedness of use of the mobile computing device 100 by the user, module 202 provides data indicative of such inference to the user interface adaption module 204. The user interface adaption module 204 in configured to adapt the user interface of the mobile computing device 100 based on the determined handedness. Such adaption may include adapting the visual characteristics of a graphical user interface of the mobile computing device 100, adapting the operation of the user interface, adapting the response of the user interface to input by the user, and/or other modifications. For example, as discussed in more detail below, the user interface adaption module 204 may modify or transform a user's tactile input (e.g., a tactile gesture); modify the location, size, or appearance of menus, widgets, icons, controls, or other display graphics; rearrange, replace, or relocate menus, widgets, icons, controls, or other display graphics; ignore erroneous tactile input; and/or other features or characteristics of the user interface of the mobile computing device 100 based on the determined handedness of use.

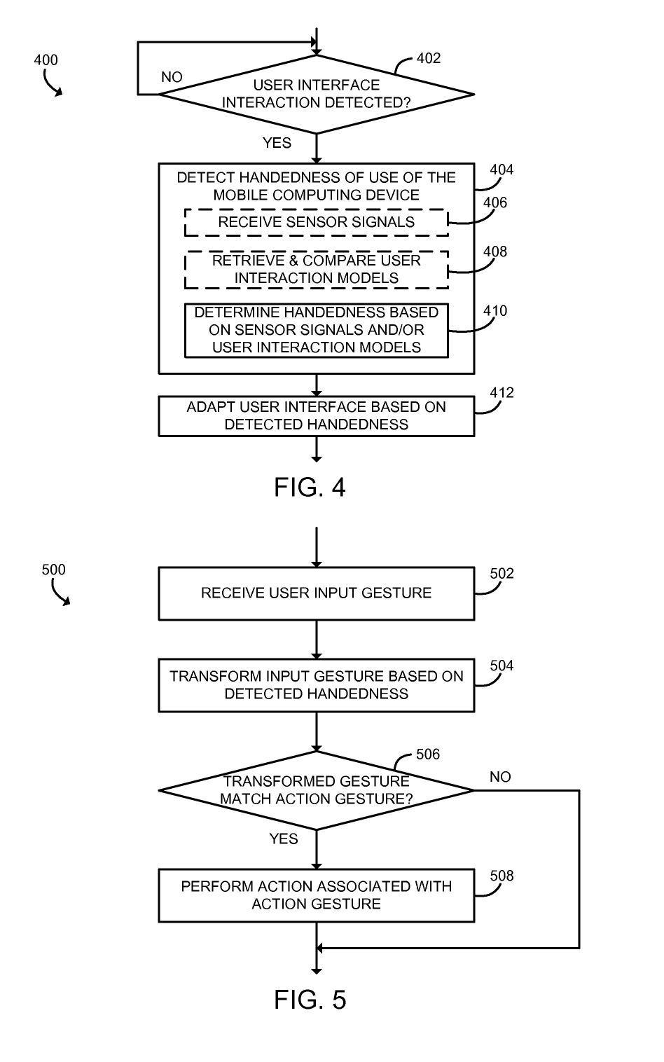

Referring now to FIG. 4, in use, the mobile computing device 100 may execute a method 400 for adapting a user interface based on handedness of use of the device 100. The method 400 begins with block 402 in which the mobile computing device 100 determines whether a user interface interaction has been detected. For example, the mobile computing device 100 determines whether one or more tactile input has been received via the touchscreen display 110. In other embodiments, the mobile computing device 100 may infer a user interface interaction upon power-up or in response to being awoken after a period of sleep or inactivity.

In block 404, the mobile computing device 100 determines or infers the handedness of use of the device 100 by the user. As discussed above, the mobile computing device 100 may use one or more data sources to infer such handedness of use. For example, in some embodiments, the handedness detection module 202 of the mobile computing device 100 may receive sensor signals from the sensors 120 in block 406. Additionally, in some embodiments, the handedness detection module 202 may retrieve one or more user interaction models 210 from data storage or memory 106 in block 408. Subsequently, in block 410, the handedness detection module 202 determines or infers the handedness of use of the mobile computing device 100 based on the sensor signals from the sensors 120 and/or the user interaction models 210. To do so, the handedness detection module 202 may analyze and compare the sensor signals from the sensors 120, perform image analysis of images generated by one or more sensors 120, and/or compare the user interaction models 210 to the current user interaction as discussed in more detail above. The handedness detection module 202 may infer continuously, periodically, or responsively the handedness of use of the mobile computing device 100.

After the handedness of use of the mobile computing device 100 has been inferred, the user interface adaption module 204 adapts the user interface of the mobile computing device 100 based on the inferred handedness of use of the mobile computing device 100. For example, in one embodiment, the user interface adaption module 204 is configured to adapt the user interface of the mobile computing device 100 by modifying or transforming a user input gesture. To do so, the mobile computing device 100 may execute a method 500 as illustrated in block FIG. 5. The method 500 begins with block 502 in which the mobile computing device 100 receives a tactile input gesture supplied by the user via the touchscreen display 110. In block 504, the user interface adaption module 204 transforms the input gesture based on the inferred handedness of use of the mobile computing device 100. Such transformation may be embodied as any type of modification of the received input gesture including, but not limited to, rotating the input gesture, flipping the input gesture, enlarging the input gesture, and/or shrinking the input gesture. Subsequently, in block 506, the transformed or modified input gesture is compared to one or more action gestures, which are a pre-defined gestures (e.g., an unlock gesture) associated with a predefined actions (e.g., unlocking) performed by the mobile computing device 100 in response to a user's input of the action gestures. The action gesture may be embodied as any type of tactile gesture configured to cause that activation of the corresponding action, which may be embodied as any type of action capable of being performed on the mobile computing device 100 (e.g., unlocking/locking the device 100, activating a user application, pairing the device 100 with another device, supplying input data to the device 100, etc.). If the transformed input gesture matches an action gesture, the action associated with the action gesture is performed in block 508.

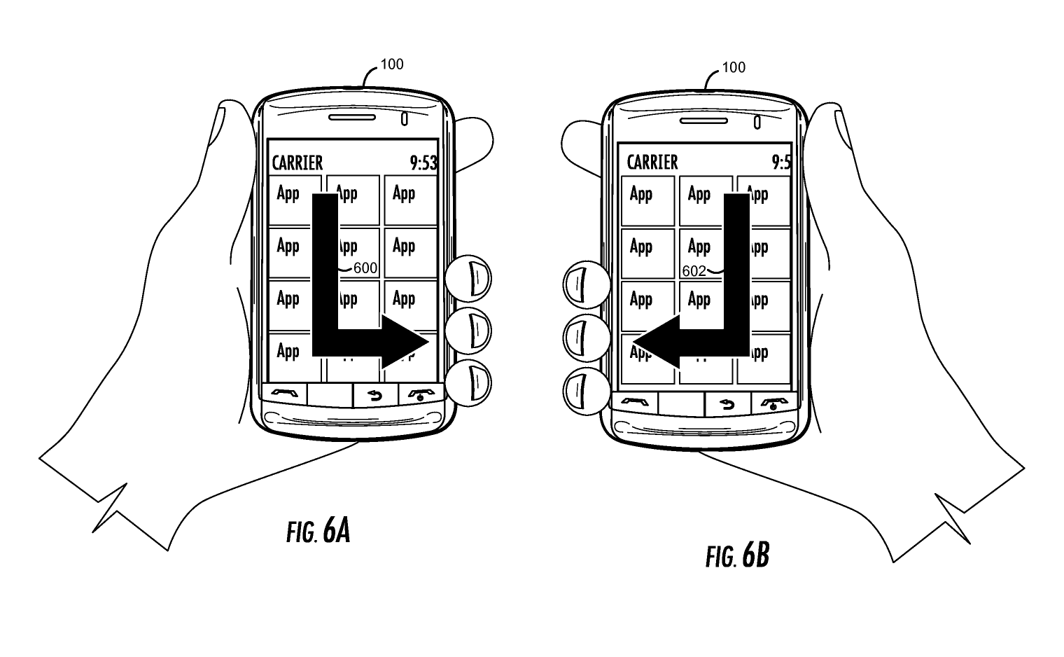

In this way, the user may perform an input gesture corresponding to an action gesture in the same manner or sequence regardless of the handedness of use of the mobile computing device 100. In some cases, the particular input gestures may be easier to perform based on the handedness of use of the mobile computing device 100. For example, it has been determined that pulling horizontally with the thumb is more difficult than pushing horizontally with thumb. As such, the input gestures corresponding to the action gesture can be modified or transformed to improve the ease entering such gestures. For example, as shown in FIGS. 6A and 6B, an unlock action gesture may be defined as “pull down, and then push away,” which has different corresponding input gestures depending on the handedness of use. That is, if the user is holding the mobile computing device 100 in his/her left hand as shown in FIG. 6A, the input gesture corresponding to the unlock action gesture may be defined as “pull down and then push to the right” as indicated by input gesture arrow 600. Conversely, if the user is holding the mobile computing device 100 in his/her right as shown in FIG. 6B, the input gesture corresponding to the unlock action gesture may be defined as “pull down and then push to the left” as indicated by input gesture arrow 602. Based on the determined handedness of use, either gesture will correspond to the action gesture as mobile computing device 100 may transform one or both gestures as a function of the determined handedness of use as discussed above. Of course, it should be appreciated that in other embodiments, the action gesture may be modified, or otherwise defined, based on the handedness of use of the mobile computing device instead of the input gestures. That is, the action gesture may be transformed based on the handedness of use and compared to the unmodified input gesture. Alternatively, multiple action gestures may be defined for a single action with a single action gesture being selected to compare to the input gesture based on the determined handedness of use of the mobile computing device 100.

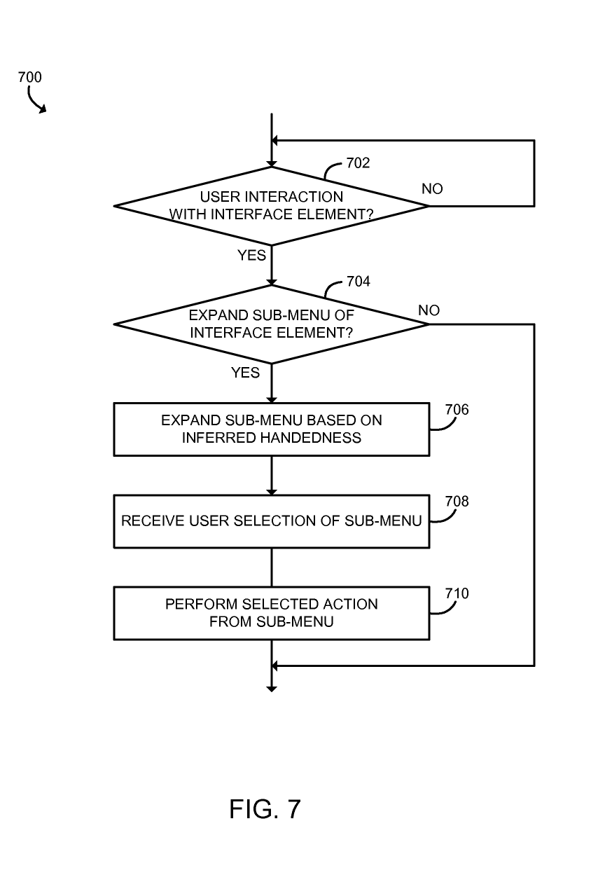

Referring now to FIG. 7, in some embodiments, the user interface adaption module 204 may adapt the user interface of the mobile computing device 100 by adapting the location and/or operation of selection or display menus. To do so, the mobile computing device 100 may execute a method 700. The method 700 begins with block 702 in which the mobile computing device 100 detects whether the user is interacting with a user interface element of the user interface of the device 100. Such user interface elements may be embodied as any type of element having a menu or sub-menu associated therewith including, but not limited to, graphical icons, widgets, selection menus, data cells, and/or the like. If the user interaction with an interface element is detected in block 702, the method 700 advances to block 704 in which the mobile computing device 100 determines whether the user is requesting to expand a menu or sub-menu associated with the user interface element. For example, in some embodiments, the user may request display (i.e., expansion) of the sub-menu by double-clicking, pressing and holding, or otherwise selecting the user interface element.

If the user has requested expansion of the sub-menu associated with the user interface element, the method 700 advances to block 706 in which the sub-menu is expanded based on the inferred handedness of use of the mobile computing device 100. For example, the sub-menu may be displayed in a location on the touchscreen display 110 based on the inferred handedness of use, expanded outwardly in a direction based on the inferred handedness of use, sized based on the inferred handedness of use, or otherwise graphically modified based on the inferred handedness of use of the mobile computing device 100. Subsequently, in block 708, the mobile computing device 100 may receive a user selection of an item of the expanded sub-menu and perform the corresponding selected action in block 710.

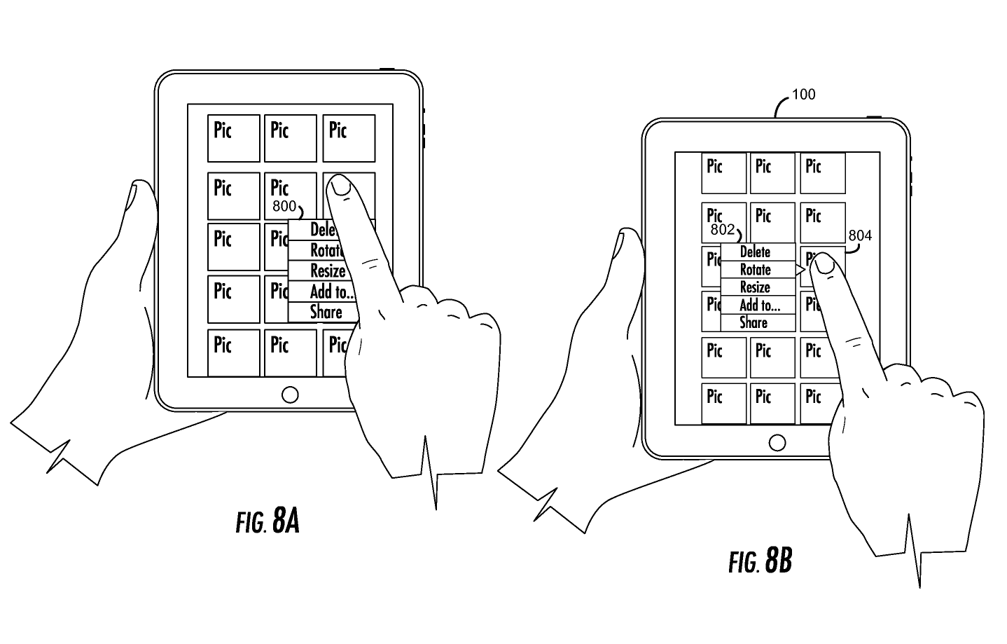

In this way, the requested menu or sub-menu may be displayed or expanded based on the inferred handedness of use of the mobile computing device 100 in such a way to improve the user's ability to view and/or interact with the sub-menu. For example, a typical mobile computing device, as shown in FIG. 8A, may expand a sub-menu 800 in a location that is partially obscured by the user's hand. Conversely, the mobile computing device 100 may execute the method 700 to expand or otherwise display a sub-menu 802 in a location on the touchscreen display 110, based on the inferred handedness of use, that improves the visibility and interactivity of the sub-menu 802 to the user as shown in FIG. 8B. In the illustrative embodiment of FIG. 8B, the sub-menu 802 has been displayed to the left of the selected user interface element 804 because the mobile computing device 100 has inferred that the user is interacting with the user interface using his/her right hand (and, perhaps, holding the device 100 in his/her left hand). Conversely, if the mobile computing device 100 had inferred that the user is interacting with the user interface using his/her left hand, the mobile computing device 100 may have displayed the sub-menu 802 below or to the right of the selected user interface element 804 similar to the sub-menu 800 of FIG. 8A.

Referring now to FIG. 9, in some embodiments, the user interface adaption module 204 may adapt the user interface of the mobile computing device 100 to ignore erroneous input based on the inferred handedness of use of the device 100. For example, during normal use, the user may inadvertently touch areas, such as the outer edge, of the touchscreen display 110. As such, the mobile computing device 100 may be configured to detect and ignore such erroneous input. To do so, the mobile computing device 100 may execute a method 900, which begins with block 702. In block 702, the mobile computing device 100 detects whether a tactile input was received within a pre-defined outer edge 1000 (see FIG. 10A) of the touchscreen display 110. The outer edge may be defined as a boundary of the touchscreen display 110 adjacent the outer surrounding edge of the touchscreen display 110. In some embodiments, the width of the outer edge may be pre-defined. For example, in some embodiments, the outer most area of the touchscreen display 110 may have a width of less than about 20% of the total width of the touchscreen display 110. Of course, defined outer edges having other dimensions may be used in other embodiments.

If the mobile computing device 100 determines that a tactile input has been received within the defined outer edge of the touchscreen display 110, the method 900 advances to block 904 in which the mobile computing device 100 determines whether the tactile input is erroneous. In some embodiments, the mobile computing device 100 may simply treat all tactile input received in the outer edge of the touchscreen display 110 as erroneous input. Alternatively, the mobile computing device 100 may analyze the tactile input, along with other input and/or data, to determine whether the received tactile input is erroneous. For example, in some embodiments, the mobile computing device 100 may determine that the tactile input is erroneous if at least one additional tactile input is received within the outer edge of the touchscreen display contemporaneously with the first tactile input. The particular outer edge in which tactile input is ignored may be based on the inferred handedness of use. For example, if the user is holding the mobile computing device 100 in his/her right hand, the device 100 may ignore multiple tactile input in the left outer edge consistent with the user's fingers inadvertently contacting the outer edge of the touchscreen display 110. If the mobile computing device 100 determines that the tactile input is erroneous, the mobile computing device 100 ignores the tactile input in block 908.

In this way, the mobile computing device 100 may improve the accuracy of the user's interaction with the touchscreen display 110 based on the handedness of use of the device 100 by identifying and ignoring erroneous tactile input. For example, as shown in FIG. 10A, a user may hold the mobile computing device 100 in his/her left hand. However, because the fingers of the user may wrap around the bezel of the housing of the mobile computing device 100, the user's fingers may contact the touchscreen display 110 as shown in FIG. 10B by contact circles 1002. If the mobile computing device 100 detects the multiple, contemporaneous tactile input in the outer edge 1000 of the touchscreen display 110 (based on the inferred handedness of use), the mobile computing device 100 may determine that such tactile input is erroneous and ignore the tactile input.

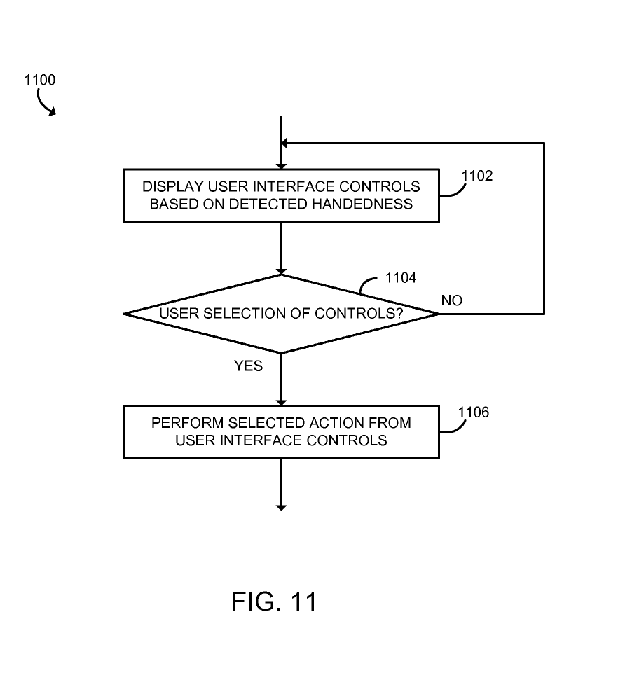

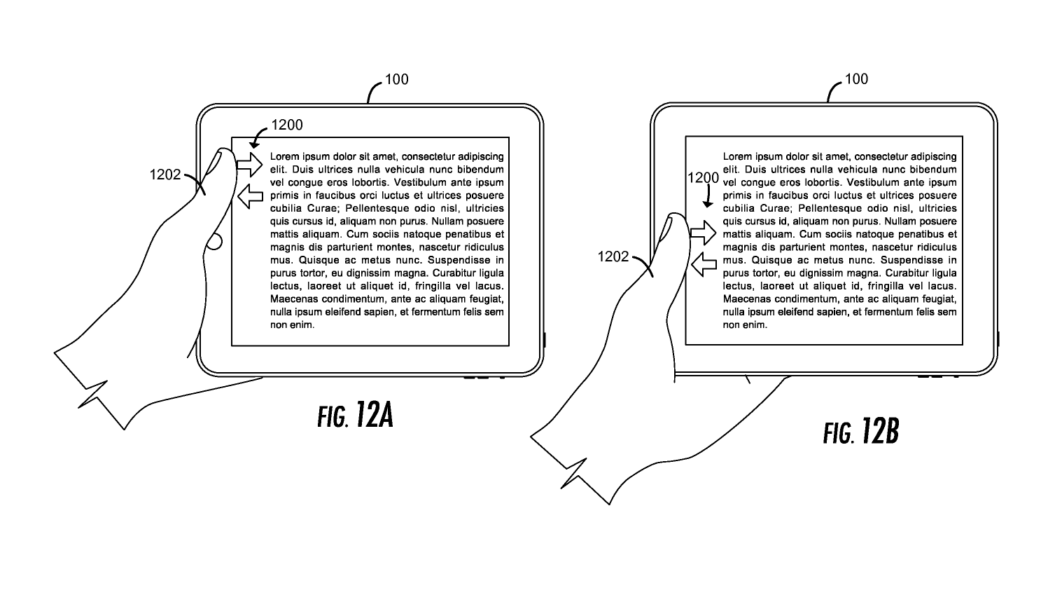

Referring now to FIG. 11, in some embodiments, the user interface adaption module 204 may adapt the user interface of the mobile computing device 100 to display user interface controls based on the inferred handedness of use of the device 100. To do so, the mobile computing device 100 may execute a method 1100. The method 1100 begins with block 1102 in which the mobile computing device 100 displays the user interface controls based on the inferred handedness of use of the mobile computing device 100. For example, the mobile computing device 100 may display the user controls in a location and/or size on the touchscreen display 110 as a function of the inferred handedness of use of the device 100. Subsequently, in block 1104, the mobile computing device determines whether the user has selected one of the user interface controls. If not, the method 1100 loops back to block 1102 wherein the display of the user interface controls is updated based on the inferred handedness of use. In this way, the location and/or size of the user controls may be modified as the user adjusts the way he/she holds the mobile computing device. For example, as shown in FIG. 12A, a set of user controls 1200 is displayed in a location on a user interface of the mobile computing device 100 based on the inferred handedness of use of the device 100. That is, in the illustrative embodiment, the mobile computing device 100 has inferred that the user is holding the mobile computing device 100 in his/her left hand and, as such, has displayed the set of user controls 1200 in a location near the detected location of the user's thumb 1204. However, as the user adjusts the way in which he/she is holding the mobile computing device 100 as shown in FIG. 12B, the mobile computing device 100 similarly changes the location of the set of user controls 1200 such that the user controls 1200 remain near the user's thumb 1204 for easy access and control.

Referring back to FIG. 11, if the mobile computing device determines that the user has selected one of the user controls in block 1104, the method 1100 advances to block 1106. In block 1106, the mobile computing device performs the action associated with the selected user control. Such action may be embodied as any type of action capable of being activated by selection of a corresponding user control. Additionally, the user controls may be adapted or otherwise modified in other ways in other embodiments.

It should be appreciated that although only several embodiments of user interface adaptions have been described above, the user interface, or operation thereof, of the mobile computing device 100 may be adapted in other ways in other embodiments. For example, should the computing device 100 determine that the user is using his/her thumb for data input, the user interface adaption module 204 of the computing device 100 may reposition, enlarge, or otherwise reconfigure a menu, widget, button, or other control of the user interface to adapt the user interface for use with a user's thumb (which is generally larger than the user's fingers). In this way, the interface adaption module 204 may utilize any type of adaption, reconfiguration, resizing, reposition, or other modification of any one or more menu, widget, button, user control, or other component of the user interface to adapt the user interface to the user's handedness of use of the computing device 102.

### EXAMPLES

Illustrative examples of the devices, systems, and methods disclosed herein are provided below. An embodiment of the devices, systems, and methods may include any one or more, and any combination of, the examples described below.

Example 1 includes a mobile computing device for adapting a user interface displayed on a touchscreen display of the mobile computing device. The mobile computing device comprises at least one sensor to generate one or more sensor singals indicative of the presence of a hand of the user on the mobile computing device; a handedness detection module to determine a handedness of use of the mobile computing device by the user as a function of the one or more sensor singals; and a user interface adaption module to adapt operation of a user interface displayed on the touchscreen display as a function of the determined handedness of use of the mobile computing device.

Example 2 includes the subject matter of Example 1, and wherein the at least one sensor comprises a sensor located on side of a housing of the mobile computing device.

Example 3 includes the subject matter of any of Examples 1 and 2, and wherein the at least one sensor comprises a sensor located on a back side of the housing of the mobile computing device.

Example 4 includes the subject matter of any of Examples 1-3, and wherein the at least one sensor comprises at least one of: a capacitive touch sensor, a resistive touch sensor, a pressure sensor, a light sensor, a touchscreen sensor, or a camera.

Example 5 includes the subject matter of any of Examples 1-4, and wherein the handedness detection module is to determine the handedness of use of the mobile computing device by determining the location of at least one finger and at least one thumb of the user's hand as a function of the sensor signal.

Example 6 includes the subject matter of any of Examples 1-5, and wherein the handedness detection module is to determine the handedness of use by inferring which hand of the user is currently holding the mobile computing device as a function of the sensor signal.

Example 7 includes the subject matter of any of Examples 1-6, and wherein the handedness detection module is further to receive a tactile input from the user using the touchscreen display; retrieve a user interaction model from a memory of the mobile computing device, the user interaction model correlating user interaction with the mobile computing device to handedness of use of the mobile computing device; and determine the handedness of use of the mobile computing device as a function of the sensor signal, the tactile input, and the user interaction model.

Example 8 includes the subject matter of any of Examples 1-7, and wherein the user interaction model comprises a historical user interaction model that correlates historical user interaction with the mobile computing device to handedness of use of the mobile computing device.

Example 9 includes the subject matter of any of Examples 1-8, and wherein the user interface is a graphical user interface.

Example 10 includes the subject matter of any of Examples 1-9, and wherein the user interface adaption module adapts an input gesture from the user received via the touchscreen display as a function of the determined handedness of use of the mobile computing device.

Example 11 includes the subject matter of any of Examples 1-10, and wherein the user interface adaption module is to perform a transformation on the input gesture to generate a modified input gesture; compare the modified input gesture to an action gesture; and enable the performance of an action determined by the action gesture in response to the modified input gesture matching the action gesture.

Example 12 includes the subject matter of any of Examples 1-11, and wherein the transformation comprises a transformation of the input gesture selected from the group consisting of: rotating the input gesture, flipping the input gesture, enlarging the input gesture, and shrinking the input gesture.

Example 13 includes the subject matter of any of Examples 1-12, and wherein the user interface adaption module adapts a submenu of the user interface generated in response to a user's selection of a user interface element displayed on the touchscreen display as a function of the determined handedness of use of the mobile computing device.

Example 14 includes the subject matter of any of Examples 1-13, and wherein the user interface adaption module is to expand the submenu based on the determined handedness of use of the mobile computing device.

Example 15 includes the subject matter of any of Examples 1-14, and wherein adapting the submenu comprises displaying the submenu in a location on the touchscreen as a function of the determined handedness.

Example 16 includes the subject matter of any of Examples 1-15, and wherein the user interface adaption module is to display the submenu in a location on the touchscreen as a function of the current location of at least one finger of the user.

Example 17 includes the subject matter of any of Examples 1-16, and wherein the user interface adaption module comprises a user interface adaption module to ignore a tactile input received via the touchscreen display as a function of the determined handedness of use of the mobile computing device.

Example 18 includes the subject matter of any of Examples 1-17, and wherein the user interface is to receive, from the touchscreen display, a tactile input located in an outer edge of the touchscreen display, and ignore the tactile input as a function the handedness of the mobile computing device and the location of the tactile input.

Example 19 includes the subject matter of any of Examples 1-18, and wherein the outer edge of the touchscreen display has a width of no more than 20% of the total width of the touchscreen display.

Example 20 includes the subject matter of any of Examples 1-19, and wherein the user interface is to receive, from the touchscreen display, multiple contemporaneous tactile inputs located in the outer edge of the touchscreen display, and ignore the multiple contemporaneous tactile inputs as a function of the handedness of the mobile computing device, the location of the tactile inputs, and the contemporaneousness of the tactile inputs.

Example 21 includes the subject matter of any of Examples 1-20, and wherein the user interface adaption module comprises a user interface adaption module to display at least one user interface control on the touchscreen display as a function of the determined handedness of use of the mobile computing device.

Example 22 includes the subject matter of any of Examples 1-21, and wherein the user interface adaption module is to display the least one user interface control in a location on the touchscreen display as a function of the determined handedness of use of the mobile computing device.

Example 23 includes the subject matter of any of Examples 1-22, and wherein the user interface adaption module is to display the at least one user interface control in a location on the touchscreen display that is located to the left of and above a touch location of a user's selection on the touchscreen display if the handedness of use is determined to be right-handed.

Example 24 includes the subject matter of any of Examples 1-23, and wherein the user interface adaption module is to display the at least one user interface control in a location on the touchscreen display that is located to the right of and above a touchscreen location of a user's selection on the touchscreen display if the handedness of use is determined to be left-handed.

Example 25 includes a method for adapting a user interface of a mobile computing device. The method comprises determining a handedness of use of the mobile computing device by the user; and adapting the operation of a user interface displayed on a touchscreen display of the mobile computing device as a function of the determined handedness of use of the mobile computing device.

Example 26 includes the subject matter Example 25, and wherein determining the handedness of use of the mobile computing device comprises sensing the presence of a hand of the user on the mobile computing device.

Example 27 includes the subject matter of any of Examples 25 and 26, and wherein sensing the presence of the hand of the user comprises receiving sensor signals from at least one of: a capacitive touch sensor, a resistive touch sensor, a pressure sensor, a light sensor, a touchscreen sensor, or a camera.

Example 28 includes the subject matter of any of Examples 25-27, and wherein sensing the presence of the hand of the user comprises sensing a palm and at least one finger of a hand of the user on the mobile computing device.

Example 29 includes the subject matter of any of Examples 25-28, and wherein sensing the presence of the hand of the user comprises determining the location of at least one finger and a thumb of the user's hand.

Example 30 includes the subject matter of any of Examples 25-29, and wherein determining the handedness of use of the mobile computing device comprises receiving sensor signals indicative of the presence of a hand of the user on the mobile computing device, and inferring which hand of the user is currently holding the mobile computing device as a function of the sensor signals.

Example 31 includes the subject matter of any of Examples 25-30, and further including receiving, on the mobile computing device, sensor signals indicative of the presence of a hand of the user on the mobile computing device; receiving a tactile input from the user using the touchscreen display; retrieving, on the mobile computing device, a user interaction model from a memory of the mobile computing device, the user interaction model correlating user interaction with the mobile computing device to handedness of use of the mobile computing device; and wherein determining the handedness of use of the mobile computing device comprises determining the handedness of use of the mobile computing device as a function of the sensor signals, the tactile input, and the user interaction model.

Example 32 includes the subject matter of any of Examples 25-31, and wherein retrieving a user interaction model comprises retrieving a historical user interaction model that correlates historical user interaction with the mobile computing device to handedness of use of the mobile computing device.

Example 33 includes the subject matter of any of Examples 25-32, and wherein adapting the operation of the user interface comprises adapting a graphical user interface displayed on the touchscreen display of the mobile computing device.

Example 34 includes the subject matter of any of Examples 25-33, and wherein adapting the operation of the user interface comprises adapting an input gesture from the user received via the touchscreen display.

Example 35 includes the subject matter of any of Examples 25-34, and wherein adapting the input gesture comprises modifying the input gesture and comparing the modified input gesture to an action gesture, and wherein the method further comprises performing an action determined by the action gesture in response to the modified input gesture matching the action gesture.

Example 36 includes the subject matter of any of Examples 25-35, and wherein adapting the input gesture comprises performing at least one transformation on the input gesture selected from the group consisting of: rotating the input gesture, flipping the input gesture, enlarging the input gesture, and shrinking the input gesture.

Example 37 includes the subject matter of any of Examples 25-36, and wherein adapting the operation of the user interface comprises adapting a submenu of the user interface generated in response to a user's selection of a user interface element displayed on the touchscreen display.

Example 38 includes the subject matter of any of Examples 25-37, and wherein adapting the submenu comprises expanding the submenu based on the determined handedness of use of the mobile computing device.

Example 39 includes the subject matter of any of Examples 25-38, and wherein adapting the submenu comprises displaying the submenu in a location on the touchscreen as a function of the determined handedness.

Example 40 includes the subject matter of any of Examples 25-39, and wherein displaying the submenu comprises displaying the submenu in a location on the touchscreen as a function of the current location of at least one finger of the user.

Example 41 includes the subject matter of any of Examples 25-40, and wherein adapting the operation of the user interface comprises ignoring a tactile input received via the touchscreen display as a function of the determined handedness of use of the mobile computing device.

Example 42 includes the subject matter of any of Examples 25-41, and wherein ignoring a tactile input comprises receiving, using the touchscreen display, a tactile input located toward an edge of the touchscreen display, and ignoring the tactile input as a function of the handedness of the mobile computing device and the location of the tactile input.

Example 43 includes the subject matter of any of Examples 25-42, and wherein receiving a tactile input located toward and edge of the touchscreen display comprises receiving a tactile input located within an outer edge of the touchscreen display that has a width of no more than 20% of the total width of the touchscreen display.

Example 44 includes the subject matter of any of Examples 25-43, and wherein ignoring a tactile input comprises receiving more than one contemporaneous tactile inputs located toward an edge of the touchscreen display.

Example 45 includes the subject matter of any of Examples 25-44, and wherein adapting the operation of the user interface comprises displaying at least one user interface control on the touchscreen display as a function of the determined handedness of use of the mobile computing device.

Example 46 includes the subject matter of any of Examples 25-45, and wherein displaying the at least one user control comprises displaying the least one user interface control in a location on the touchscreen display as a function of the determined handedness of use of the mobile computing device.

Example 47 includes the subject matter of any of Examples 25-46, and wherein displaying the submenu comprises displaying the submenu in a location on the touchscreen display that is located to the left of and above the selected user interface element if the handedness of use is determined to be right-handed.

Example 48 includes the subject matter of any of Examples 25-47, and wherein displaying the submenu comprises displaying the submenu in a location on the touchscreen display that is located to the right of and above the selected user interface element if the handedness of use is determined to be left-handed.

Example 49 includes a computing device comprising a processor; and a memory having stored therein a plurality of instructions that when executed by the processor cause the computing device to perform the method of any of Examples 25-48.

Example 50 includes one or more machine readable storage media comprising a plurality of instructions stored thereon that in response to being executed result in a computing device performing the method of any of Examples 25-48.

1. A mobile computing device for adapting a user interface displayed on a touchscreen display of the mobile computing device, the mobile computing device comprising:
at least one sensor to generate one or more sensor signals indicative of the presence of a hand of the user on the mobile computing device;
a handedness detection module to determine a handedness of use of the mobile computing device by the user as a function of the one or more sensor signals; and
a user interface adaption module to adapt operation of a user interface displayed on the touchscreen display as a function of the determined handedness of use of the mobile computing device.

2. The mobile computing device of claim 1, wherein the at least one sensor comprises a sensor located on one of (i) a side of a housing of the mobile computing device or (ii) a back side of the housing of the mobile computing device.

3. The mobile computing device of claim 1, wherein the handedness detection module is to determine the handedness of use of the mobile computing device by determining the location of at least one finger and at least one thumb of the user's hand as a function of the sensor signal.

4. The mobile computing device of claim 1, wherein the mobile wherein the handedness detection module is further to:
receive a tactile input from the user using the touchscreen display;'
retrieve a user interaction model from a memory of the mobile computing device, the user interaction model correlating user interaction with the mobile computing device to handedness of use of the mobile computing device; and
determine the handedness of use of the mobile computing device as a function of the sensor signal, the tactile input, and the user interaction model.

5. The mobile computing device of claim 4, wherein the user interaction model comprises a historical user interaction model that correlates historical user interaction with the mobile computing device to handedness of use of the mobile computing device.

6. The mobile computing device of claim 1, wherein the user interface adaption module adapts an input gesture from the user received via the touchscreen display as a function of the determined handedness of use of the mobile computing device.

7. The mobile computing device of claim 6, wherein the user interface adaption module is to:
perform a transformation on the input gesture to generate a modified input gesture;
compare the modified input gesture to an action gesture; and
enable the performance of an action determined by the action gesture in response to the modified input gesture matching the action gesture.

8. The mobile computing device of claim 7, wherein the transformation comprises flipping the input gesture.

9. The mobile computing device of claim 7, wherein the transformation comprises a transformation of the input gesture selected from the group consisting of: rotating the input gesture, enlarging the input gesture, and shrinking the input gesture.

10. The mobile computing device of claim 1, wherein the user interface adaption module adapts a submenu of the user interface generated in response to a user's selection of a user interface element displayed on the touchscreen display as a function of the determined handedness of use of the mobile computing device.

11. The mobile computing device of claim 1, wherein the user interface adaption module comprises a user interface adaption module to ignore a tactile input received via the touchscreen display as a function of the determined handedness of use of the mobile computing device.

12. The mobile computing device of claim 1, wherein the user interface adaption module comprises a user interface adaption module to display at least one user interface control on the touchscreen display as a function of the determined handedness of use of the mobile computing device.

13. The mobile computing device of claim 12, wherein the user interface adaption module is to display the at least one user interface control in a location on the touchscreen display that is located to the left of and above a touch location of a user's selection on the touchscreen display if the handedness of use is determined to be right-handed.

14. The mobile computing device of claim 12, wherein the user interface adaption module is to display the at least one user interface control in a location on the touchscreen display that is located to the right of and above a touchscreen location of a user's selection on the touchscreen display if the handedness of use is determined to be left-handed.

15. One or more machine readable storage media comprising a plurality of instructions stored thereon that in response to being executed result in a mobile computing device:
determining a handedness of use of the mobile computing device by a user of the mobile computing device; and
adapting the operation of a user interface displayed on a touchscreen display of the mobile computing device as a function of the determined handedness of use of the mobile computing device.

16. The one or more machine readable storage media of claim 15, wherein determining the handedness of use of the mobile computing device comprises sensing the presence of a hand of the user on the mobile computing device.

17. The one or more machine readable storage media of claim 15, wherein determining the handedness of use of the mobile computing device comprises:
receiving sensor signals indicative of the presence of a hand of the user on the mobile computing device, and
inferring which hand of the user is currently holding the mobile computing device as a function of the sensor signals.

18. The one or more machine readable storage media of claim 15, wherein the plurality of instructions further result in the mobile computing device:
receiving, on the mobile computing device, sensor signals indicative of the presence of a hand of the user on the mobile computing device;
receiving a tactile input from the user using the touchscreen display;
retrieving, on the mobile computing device, a user interaction model from a memory of the mobile computing device, the user interaction model correlating user interaction with the mobile computing device to handedness of use of the mobile computing device; and
wherein determining the handedness of use of the mobile computing device comprises determining the handedness of use of the mobile computing device as a function of the sensor signals, the tactile input, and the user interaction model.

19. The one or more machine readable storage media of claim 15, wherein adapting the operation of the user interface comprises modifying an input gesture from the user received via the touchscreen display and comparing the modified input gesture to an action gesture,
and the plurality of instructions further result in the mobile computing device performing an action determined by the action gesture in response to the modified input gesture matching the action gesture.

20. The one or more machine readable storage media of claim 15, wherein adapting the operation of the user interface comprises at least one of: (i) expanding a submenu of the user interface generated in response to a user's selection of a user interface element displayed on the touchscreen display based on the determined handedness of use of the mobile computing device and (ii) displaying the submenu in a location on the touchscreen display as a function of the determined handedness.

21. The one or more machine readable storage media of claim 20, wherein displaying the submenu comprises displaying the submenu in a location on the touchscreen display that is located to the left of and above the selected user interface element if the handedness of use is determined to be right-handed.

22. The one or more machine readable storage media of claim 20, wherein displaying the submenu comprises displaying the submenu in a location on the touchscreen display that is located to the right of and above the selected user interface element if the handedness of use is determined to be left-handed.

23. The one or more machine readable storage media of claim 15, wherein adapting the operation of the user interface comprises ignoring a tactile input received via the touchscreen display as a function of the determined handedness of use of the mobile computing device.

24. A method for adapting a user interface of a mobile computing device, the method comprising:
determining a handedness of use of the mobile computing device by the user; and
adapting the operation of a user interface displayed on a touchscreen display of the mobile computing device as a function of the determined handedness of use of the mobile computing device.

25. The method of claim 24, wherein determining the handedness of use of the mobile computing device comprises determining in which hand the user is holding the mobile computing device based on sensor signals indicative of the presence of a hand of the user on the mobile computing device.
